(19) United States
(12) Patent Application Publication
(10) Pub. No.: US 2016/0189124 A1
(43) Pub. Date: Jun. 30, 2016

(54) DATA BILLING SYSTEM IN MOBILE COMMUNICATION NETWORK

(71) Applicant: KOREA ADVANCED INSTITUTE OF SCIENCE AND TECHNOLOGY, Daejeon (KR)

(72) Inventors: Kyoung-soo PARK, Daejeon (KR); Young-hwan GO, Seoul (KR); Yong-dae KIM, Daejeon (KR)

(21) Appl. No.: 14/907,969

(22) PCT Filed: Jan. 16, 2015
(86) PCT No.: PCT/KR2015/000472

§ 371 Date: Jan. 27, 2016

(30) Foreign Application Priority Data
Jan. 21, 2014 (KR) 10-2014-0007309

(51) Int. Cl. G06Q 20/14; G06Q 20/10

(52) U.S. Cl. CPC G06Q 20/145; G06Q 20/102

(57) ABSTRACT

A data billing system is provided. According to at least one embodiment of the present disclosure, a payload of an IP packet is stored whenever the IP packet is received. When a retransmitted packet retransmitted based on a TCP is received, an attack packet is detected by comparing the stored payload with a payload of the retransmitted packet. This prevents a malicious attack in which a misuser desires to use data transmitted over a mobile communication network free of charge by inserting an attack packet in the payload of the retransmitted packet.

### TECHNICAL FIELD

The present disclosure in some embodiments relates to a data billing system in mobile communication networks.

### BACKGROUND

The statements in this section merely provide background information related to the present disclosure and do not necessarily constitute prior art.

Packet retransmission is one of the Transmission Control Protocol (TCP) feature that ensures reliable data transfer between end nodes. Most cellular Internet service providers (ISPs) adopt byte-level accounting of consumed Internet protocol (IP) packets that flow through their 3G/4G cellular networks. Some of the transmitted IP packets are retransmissions on the basis of the TCP. Given that over 95% of cellular traffic is based on the TCP, ISPs significantly affect the majority of cellular traffic by strategically adopting their accounting policy in practice.

The method for billing for retransmitted packets is largely classified into a “blind accounting” to charge for every IP packet regardless of the retransmission conditions and a “selective accounting” to exempt the data user from the charge for justified packet retransmissions. ISPs might argue that all retransmitted IP packets should be accounted for billing since they consume the resources of their infrastructure. On the other hand, users might want a deduction for unused data from the bill.

Despite the service subscribers' preference to such selective accounting, failure to charge for a retransmitted packet may cause some problems. For instance, there may be a possibility of malicious attempts by an attacker or misuser to steal data by inserting a free-riding IP packet (hereinafter, referred to as an “attack packet”) into the actual payload of a TCP retransmitted packet.

### DISCLOSURE

### Technical Problem

Therefore, the present disclosure provides a data billing system for preventing a malicious attack in which a misuser desires to use data free of charge by inserting an attack packet into the payload of a TCP retransmitted packet.

### SUMMARY

In accordance with some embodiments, the present disclosure provides a data billing system including a payload storage, a payload comparator and a billing unit. The payload storage is configured to store payloads of one or more Internet protocol (IP) packets transmitted over a mobile communication network. The payload comparator is configured to compare a payload of at least one retransmitted packet retransmitted among the IP packets based on a transmission control protocol (TCP) with at least one of the payloads stored in the payload storage. The billing unit is configured to determine whether to bill for the retransmitted packet or not based on a comparison result of the payload comparator.

In some embodiments, the billing unit is configured not to bill for the retransmitted packet which is regarded as a normal retransmission packet if the payload of the retransmitted packet is determined equal to the at least one of the payloads stored in the payload storage, and to bill for the retransmitted packet which is regarded as a billable retransmission packet if the payload of the retransmitted packet is determined not equal to any of the payloads stored in the payload storage.

The the payload storage may store at least one entry including partial data selected from data constituting the payloads of the IP packets.

The selected partial data may have an offset value determined by using at least one hash function.

The the hash function may include a flow key generated per flow (per_flow_key) and a base sequence number of the entry as its inputs.

The the flow key may be determined by Equation:

per_flow_key=HMAC_{secret}_{_}_{key}(nonce)

where “HMAC” denotes a hash-based message authentication code, “secret_key” is a secret key of the data billing system, and “nonce” is a random number generated per flow.

The secret key may be changeable regularly or randomly.

In accordance with some embodiments, the present disclosure provides a data billing method including generating a buffer for storing payloads of one or more Internet protocol (IP) packets transmitted over a mobile communication network, storing all of the data constituting the payloads of the IP packets in the buffer, comparing all the data of a payload of at least one retransmitted packet retransmitted among the IP packets based on a transmission control protocol (TCP) with all of data constituting a payload of at least one of the IP packets stored in the buffer, and determining not to bill for the retransmitted packet if the payload of the retransmitted packet is determined equal to at least one of the payloads of the IP packets stored in the buffer, and to bill for the retransmitted packet if the payload of the retransmitted packet is determined not equal to any of the payloads of the IP packets stored in the buffer.

In accordance with some embodiments, the present disclosure provides a data billing method for determining whether to bill for a packet retransmitted based on a transmission control protocol (TCP) over a mobile communication network. The data billing method includes generating a flow table for storing a part of payloads of one or more IP packets transmitted over the mobile communication network, storing a selected portion of data constituting the payloads of the IP packets in the flow table, comparing a selected portion of data constituting a payload of at least one retransmitted packet retransmitted among the IP packets based on the TCP with the selected portion stored in the flow table from the data constituting the payloads of the IP packets, and determining not to bill for the retransmitted packet if the payload of the retransmitted packet is determined equal to at least one of the payloads of the IP packets, and to bill for the retransmitted packet if the payload of the retransmitted packet is determined not equal to any of the payloads of the IP packets.

In accordance with some embodiments, the present disclosure provides a system for metering usage of data, including a payload storage, a payload comparator and a data usage measurer. The payload storage is configured to store payloads of one or more Internet protocol (IP) packets transmitted over a mobile communication network. The payload comparator is configured to compare a payload of at least one retransmitted packet retransmitted among the IP packets based on a transmission control protocol (TCP) with at least one of the payloads stored in the payload storage. And the data usage measurer is configured to measure a usage of data for the retransmitted packet based on a comparison result of the payload comparator.

### Advantageous Effects

According to some embodiments of the present disclosure, payloads of one or more IP packets are stored and, upon receiving at least one packet retransmitted based on a TCP, an attack packet is detected by comparing at least one of the stored payloads with a payload of the retransmitted packet. Thereby, a misuser can be prevented from making a malicious attack in an attempt to avoid charge for use of data transmitted over a mobile communication network by inserting an attack packet in the payload of the retransmitted packet.

In addition, according to some embodiments of the present disclosure, only a portion of data constituting payloads of one or more IP packets is sampled and stored and, upon receiving at least one packet retransmitted based on the TCP, an attack packet is detected by comparing the stored data portion of the payloads with just the corresponding portion of data constituting a payload of the retransmitted packet. Thereby, the memory usage efficiency can be increased in the data billing system.

### BRIEF DESCRIPTION OF DRAWINGS

FIG. 1 is a diagram of a data billing system according to some embodiments.

FIG. 2 is a diagram of a deterministic model operation of a data billing system according to some embodiments.

FIG. 3 is a diagram of a probabilistic model operation of a data billing system according to some embodiments.

FIG. 4 is a diagram of a detailed structure of a flow table based on a probabilistic model of a data billing system according to some embodiments.

FIG. 5 is a diagram of attack detection probabilities according to changes in a sampling rate based on a probabilistic model of a data billing system according to some embodiments.

FIG. 6 is a flowchart of a data billing method performed by a deterministic model in a data billing system according to some embodiments.

FIG. 7 is a flowchart of a data billing method performed by a probabilistic model in a data billing system according to some embodiments.

### REFERENCE NUMERALS

100: data billing system
100d: deterministic model of data billing system
100p: probabilistic model of data billing system
110: payload storage
120: payload comparator
130: bill determiner

### DETAILED DESCRIPTION

Hereinafter, at least one embodiment of the present disclosure will be described in detail with reference to the accompanying drawings.

In the following description, like reference numerals designate like elements although the elements are shown in different drawings. Further, in the following description of the at least one embodiment, a detailed description of known functions and configurations incorporated herein will be omitted for the purpose of clarity and for brevity.

Additionally, in describing the components of the present disclosure, terms like first, second, A, B, (a), and (b) are used. These are solely for the purpose of differentiating one component from another, and one of ordinary skill would understand that the terms are not to imply or suggest the substances, order or sequence of the components. If a component is described as ‘connected’, ‘coupled’, or ‘linked’ to another component, one of ordinary skill in the art would understand that the components are not necessarily directly ‘connected’, ‘coupled’, or ‘linked’ but also are indirectly ‘connected’, ‘coupled’, or ‘linked’ via a third component.

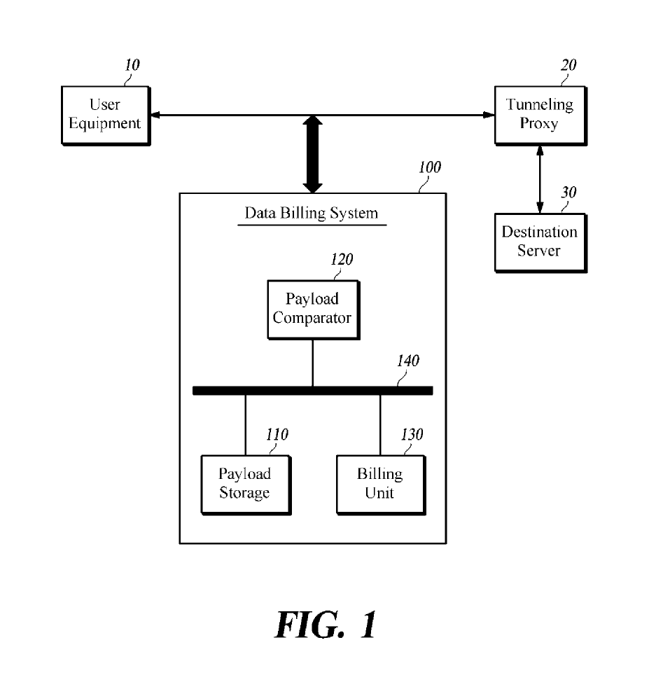

FIG. 1 is a diagram of a data billing system 100 according to some embodiments. The data billing system 100 includes a payload storage 110, a payload comparator 120 and a billing unit 130. A user equipment (UE) 10 is connected to a destination server 30 via a tunneling proxy 20. The data billing system 100 is configured to be connected to the UE 10 and the tunneling proxy 20. The tunneling proxy 20 performs a de-tunneling with respect to a tunneled packet transmitted from the UE 10 in case of upstream and transmits the detunneled stream to the destination server 30. In explaining the data billing system 100 according to some embodiments of the present disclosure, an example case illustrates that data is transmitted uplink from the UE 10 to the destination server 30 and a misuser attacks the data billing system 100 as well as the tunneling proxy 20, although the present disclosure is not limited thereto.

The payload storage 110 is configured to store payloads of IP packets at every reception of an IP packet corresponding to each flow. The payload storage 110 stores all or a part of the payloads of the IP packets. The payload comparator 120 compares a payload of at least one IP packet stored in the payload storage 110 with a payload of at least one retransmitted packet based on a TCP. The billing unit 130 determines whether to charge or bill for the retransmitted packet according to a comparison result of payloads performed by the payload comparator 120.

The components of the data billing system 100 may be connected to each other by a bus 140. The bus 140 is a communication path for connecting each unit or each module in the data billing system 100 and may be implemented by a variety of types of buses such as an address bus, a data bus, a control bus and a field bus.

The data billing system 100 in which the payload storage 110 stores all of payloads of IP packets will be referred to as a “data billing system 100d of a deterministic model” while the data billing system 100 in which the payload storage 110 is configured to store a part of the payloads of the IP packets is referred to as a “data billing system 100p of a probabilistic model.” The configurations and operations of the data billing system 100d of the deterministic model and the data billing system 100p of the probabilistic model will be respectively described.

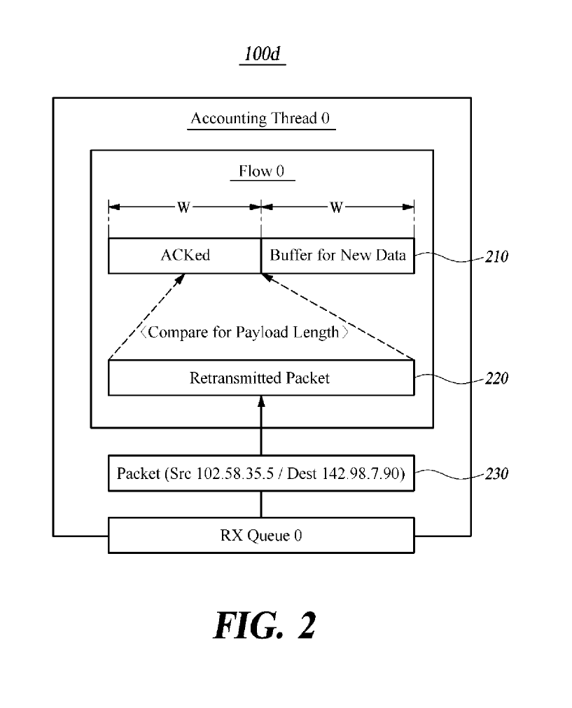

FIG. 2 is a diagram of an operation of the deterministic model of data billing system 100d according to some embodiments. When a TCP 3-way handshake process leads to form at least one flow, the billing system 100d generates for each of the directions A and B a buffer 210 for storing a payload of an IP packet 230. The IP packet 230 is transmitted in a direction from the UE 10 to the destination server 30 (hereinafter, direction “A”) and in the opposite direction from the destination server 30 to the UE 10 (hereinafter, direction “B”). The size of each buffer 210 is determined in the manner as follows. Assuming that S is a current maximum value of a sequence number of a TCP packet transmitted in each of the directions A and B and the size of a TCP receive window is W, since the billing system 100d needs to hold deleting and to store payloads of packets from which an acknowledgement (ACK) flag is received until comparing the stored payloads with payloads of retransmitted packets, the range of the buffer 210 is from S-2W to S. Therefore, the size of the buffer 210 is 2W.

If the UE 10 and the destination server 30 continue to communicate with each other, which in turn increases the value of S, the range of the buffer 210 is made to shift accordingly. The buffer 210 is configured to be allocated to a memory according to a lazy memory allocation scheme.

The size of the buffer 210 may be initially set to e.g., 4 Kbytes and may become increased when the total payload amount exceeds 4 Kbytes, although the present disclosure is not limited thereto.

As described above, the payload storage 110 stores all of the received payloads of the IP packet 230 corresponding to each flow. The payload comparator 120 then compares e.g., byte-by-byte the payload of a retransmitted packet 220 with at least one payload of the IP packet 230 stored in the buffer 210 of the payload storage 110 so as to determine whether the at least one payload of the IP packet 230 which had already been transmitted is identical to the payload of the retransmitted packet 220.

If the at least one payload of the IP packet 230 which had already been transmitted is identical to that of the retransmitted packet 220, the billing unit 130 regards the retransmitted packet 220 as a normal retransmission packet to waive a charge for the retransmitted packet 220. In contrast, if the at least one payload of the IP packet 230 which had already been transmitted is different from that of the retransmitted packet 220, the billing unit 130 regards the retransmitted packet 220 as a malicious attack packet and proceeds to bill for the retransmitted packet 220.

As in the foregoing description, whenever the retransmitted packet 220 is received, an attack packet can be distinguished from the retransmitted packet 220 and thereby a misuser may be barred from making a malicious attack in an attempt to avoid paying for use data of transmitted over a mobile communication network by e.g., inserting an attack packet into the payload of the retransmitted packet 220.

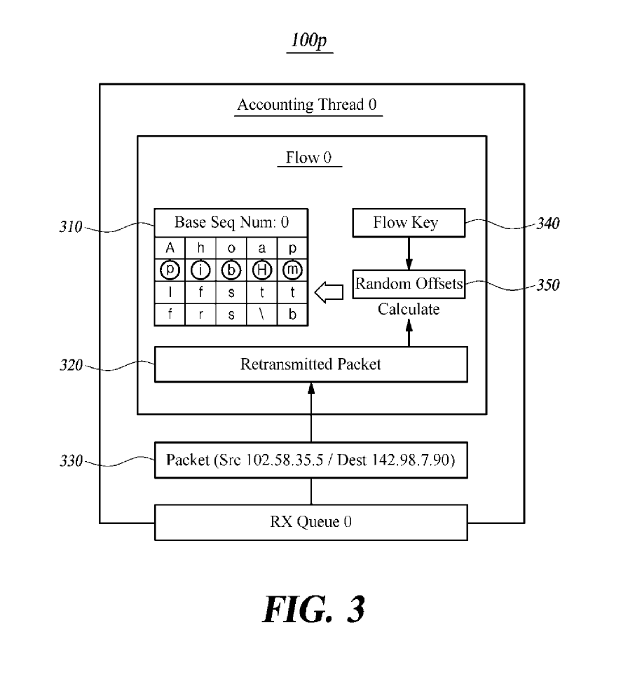

FIG. 3 is a diagram of an operation of the probabilistic model of data billing system 100p according to some embodiments of the invention. In contrast to the deterministic model, the probabilistic model of data billing system 100p is configured to allow the payload storage 110 not to store all of the payloads of the IP packets but to store only a sampled payload portion among the payloads of IP packets. For example, if the payload storage 110 stores only 5 bytes of data out of a payload of the 1000 byte size, the memory occupancy is reduced to 1/200 as compared with storing all the 1000 bytes.

When a flow is generated, the payload storage 110 generates a flow table 310 for each of the directions A and B for storing at least one entry composed of partially sampled data out of the payload of the IP packet 230.

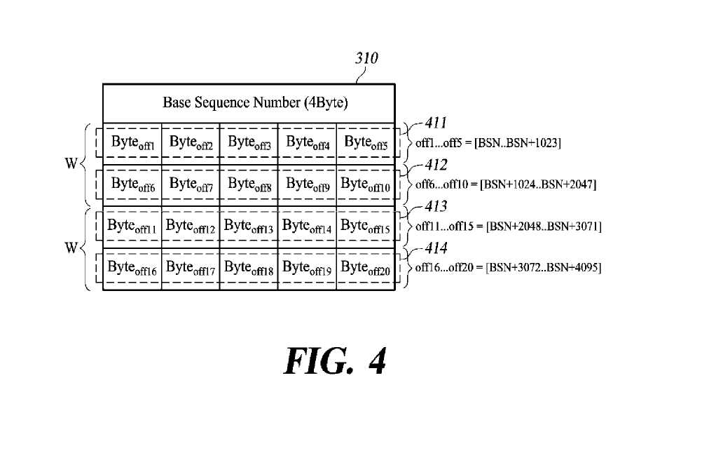

FIG. 4 is a diagram of a detailed structure of a flow table 310 based on the probabilistic model of data billing system 100p according to some embodiments. As for a 1024-byte size payload, the payload storage 110 generates entries 411, 412, 413 and 414 by sampling only n bytes of data out of 1024 bytes of data constituting the payload. Each of the entries 411 to 414 includes a 4-byte base sequence number (hereinafter, “BSN”) and n-byte sampled data. The one or more bytes of sampled data constituting each of the entries 411 to 414 may be randomly selected from a sequence number space of [BSN, BSN+1023]. The BSN for the first entry 411 defines an initial sequence number (ISN) which is set by the sequence number used in an synchronization (SYN) or SYN flag packet or an SYN/ACK packet. In addition, the BSNs of the other entries 412, 413 and 414 are set to be respectively incremented by 1024 from the ISN.

As shown in FIG. 4, in explaining the structure and operation of the probabilistic model of data billing system 100p according to some embodiments of the present disclosure, an example case is described as having n of 5, although the present disclosure is not limited thereto and a method of selecting the appropriate n will be described separately.

The positions of the sampled bytes Byte_{off1} to Byte_{off20} of data for each flow are determined by a hash function having, as inputs, a flow key (per_flow_key) 340 determined by Equation 1 and the BSNs of the entries 411 to 414. In explaining the structure and operation of the probabilistic model of data billing system 100p according to some embodiments of the present disclosure, an example case is described as a Bernstein hash function having a function value of 64 bits, although any hash function may be used if the size of the function value is greater than (10×n) bits. In more detail, with each of the entries 411 to 414 storing only n bytes of data out of the 1024-byte size payload, an offset of 1024 bytes of data per byte unit may be expressed by 2 to the 10th power (2¹⁰=1024). In order to express the individual positions of 5 bytes of data in this case of n being 5, 50 (=10×5) bits are needed, and therefore it is suffice to have a function value of 50 bits or more for the hash function.

In Equation 1, “nonce” is an 8-byte random number generated per flow, “secret_key” is a system secret key of the data billing system 100p, and “HMAC” denotes a hash-based message authentication code. The system secret key may be changed when the billing system 100p is under light load, for example, early in the morning.

per_flow_key=HAMC_{secret key}(nonce) Equation 1

Then, when the data billing system 100p detects the retransmitted packet 320, the payload comparator 120 searches for a flow corresponding to the retransmitted packet 320 by using the IP address and port number of a source/destination of the retransmitted packet 320. If the flow is present, the payload comparator 120 calculates the BSN of at least one of the entries 411˜414 to which the retransmitted packet 320 belongs, and determines the position value or random offset 350 of sampled bytes Byte_{off1} to Byte_{off20} of data by executing the hash function with the calculated BSN and the flow key 340. Given that n is 5 and the execution result of the Bernstein hash function is 64 bits, the first 10 bits of the 64 bits are selectively assigned to the random offset 350 of the first sampled byte Byte_{off1} data, the 11th to 20th bits thereof are selectively assigned to the random offset 350 of the second sampled byte Byte_{off2} data, and so on to determine the respective random offsets 350 of the sampled bytes Byte_{off1} to Byte_{off20} of data.

If the values of 5 bytes of data sampled based on the random offset 350 are respectively identical to the corresponding values of 5 bytes of data among the sampled bytes Byte_{off1} to Byte_{off20} of data stored in the flow table 310, the billing unit 130 regards the retransmitted packet 320 as a normal retransmission packet and waives a charge for the retransmitted packet 320.

If the values of the 5 bytes of data sampled based on the random offset 350 are respectively different from the corresponding values of 5 bytes of data among the sampled bytes Byte_{off1} to Byte_{off20} of data stored in the flow table 310, the billing unit 130 regards the retransmitted packet 320 as a malicious attack packet and proceeds to charge for the retransmitted packet 320.

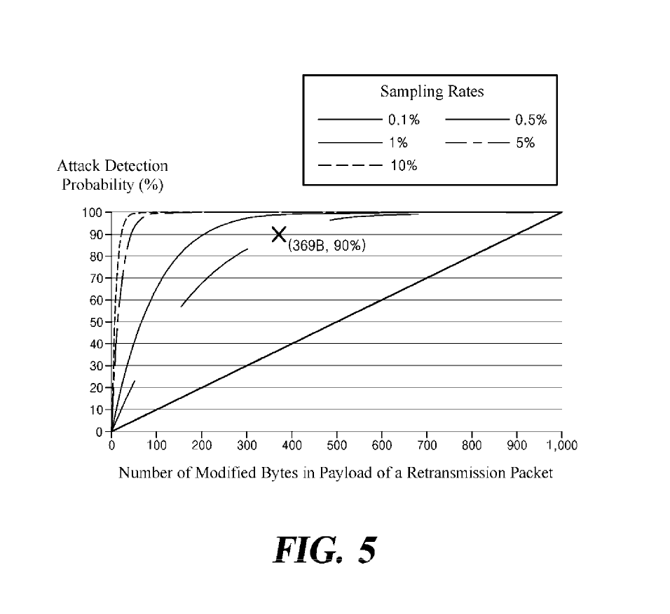

FIG. 5 is a diagram of attack detection probability P according to changes in a sampling rate based on the probabilistic model 100p of the data billing system 100 according to some embodiments. The change in the sampling rate means the change in n. For an appropriate selection of n, it needs a tradeoff between the usage of the memory of the data billing system 100p and an attack detection probability P. Smaller value of n allows less usage of the memory but reduces the attack detection probability P. In contrast, greater value of n increases the attack detection probability P as well as the usage of the memory. If the size of the payload of an IP packet 330 is 1,000 bytes, Equation 2 may be used to calculate the attack detection probability P when the data billing system 100p samples y bytes of data and a misuser changes the payload of the IP packet 330 by x bytes. FIG. 5 illustrates changes of the attack detection probability P, determined by Equation 2 according to changes in the number (x) of bytes of data changed in the payload of the retransmitted packet 320 and in the number (y) of bytes of data sampled in the payload of the retransmitted packet 320. According to some embodiments of the present disclosure, it can be appreciated that the probabilistic model 100p of the data billing system 100 has n of 5, and therefore y becomes 5 (sampling rate: 0.5%) and the attack detection probability P becomes 90% when x is 369 bytes.

$$P = 1 - \frac{{}_{( 1000 - y )}^{}{C}{}_{x}^{}}{{}_{1000}^{}{C}{}_{x}^{}} \qquad Equation 2$$

As described above, according to the probabilistic model 100p of the data billing system 100 in some embodiments of the present disclosure, an attack packet is detected by comparing partial bytes of data of a prestored payload only with partial bytes of corresponding data of the payload of the retransmitted packet 320 to reduce the memory occupancy of the data billing system 100p, thereby increasing the efficiency of memory use.

In addition to the aforementioned performance of billing for a TCP retransmitted packet transmitted in the mobile communication network, the data billing system 100 according to some embodiments may be used for measuring the usage of data transmitted in a mobile communication network.

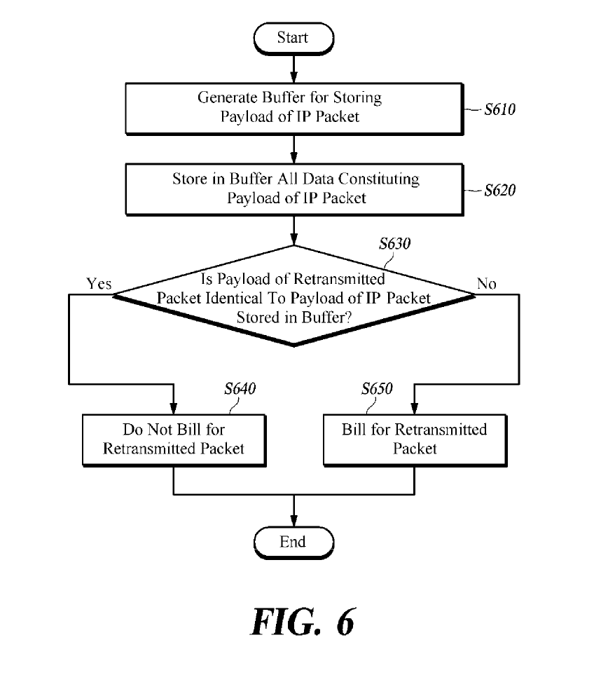

FIG. 6 is a flowchart of a data billing method performed by the deterministic model 100d in the data billing system 100 according to some embodiments. The data billing method performed by the deterministic model 100d includes generating the buffer 210 for storing the payload of the IP packet 230 (step S610), storing all data constituting the payload of the IP packet 230 in the buffer 210 (step S620), comparing the payload of the retransmitted packet 220 retransmitted by a TCP with at least one payload of the IP packet 230 stored in the buffer 210 to see if they are identical to each other (step S630), not billing or waiving a charge for the retransmitted packet 220 (step S640) when the payload of the retransmitted packet 220 is identical to the payload stored in the buffer 210, and billing for the retransmitted packet 220 when the payload of the retransmitted packet 220 is different from the payload stored in the buffer 210 (step S650). The order of the steps described above may be changed or may be simultaneously performed to achieve the data billing method by the deterministic model 100d. Therefore, the present disclosure is not limited to the order as stated herein.

If a flow is generated, the billing system 100d generates the buffer 210 in each of directions A and B for storing the payload of the IP packet 230 (step S610).

Given S is a current maximum value of a sequence number of a TCP headed in each of the directions A and B and that W represents the size of a TCP receive window, the buffer 210 has a range of S-2W to S and the size of 2W. Upon every receipt of the IP packet 230 corresponding to each flow, the payload storage 110 stores all data constituting the payload of the IP packet 230 in the buffer 210 (step S620).

The payload comparator 120 determines whether the payload of the IP packet 230 which has already been transmitted is identical to the payload of the retransmitted packet 220 by performing a complete byte-wise data comparison of the payload of the retransmitted packet 220 with the payload stored in the buffer 210 (step S630). If the payload of the already transmitted IP packet 230 is identical to the payload of the retransmitted packet 220, the billing unit 130 regards the retransmitted packet 220 as a normal retransmission packet and waives a charge for the retransmitted packet 220 (step S640). In contrast, if the payload of the already transmitted IP packet 230 is different from the payload of the retransmitted packet 220, the billing unit 130 regards the retransmitted packet 220 as a malicious attack packet and renders the retransmitted packet 220 to be charged (step S650).

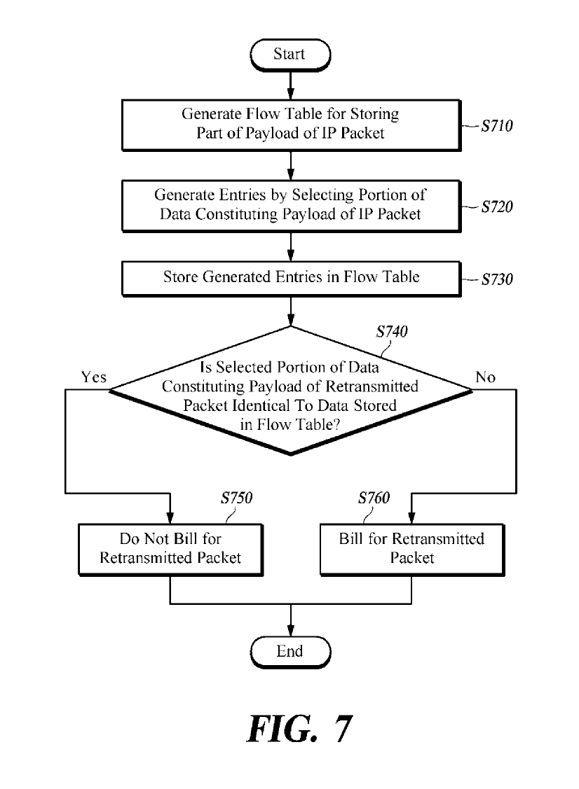

FIG. 7 is a flowchart of a detailed data billing method performed by the probabilistic model 100p in the data billing system 100 according to some embodiments. The data billing method performed by the probabilistic model 100p includes generating the flow table 310 for storing a part of the payload of the IP packet 330 (step S710), generating the entries 411 to 414 from selection of a portion of data constituting the payload of the IP packet 330 (step S720), storing the generated entries 411 to 414 respectively in the flow table 310 (step S730), comparing the selected portion of data constituting the payload of the retransmitted packet 320 with bytes Byte_{off1} to Byte_{off20} of data stored in the flow table 310 (step S740), and not billing or waiving a charge for the retransmitted packet 320 when the payload of the retransmitted packet 320 is determined to be identical to that of the IP packet 330 (step S750) and billing for the retransmitted packet 320 when the payload of the retransmitted packet 320 is not identical to that of the IP packet 330 (step S760). The order of the steps described above may be changed or may be simultaneously performed to achieve the data billing method by the data billing system of the probabilistic model 100p. Therefore, the present disclosure is not limited to the order illustrated herein.

When a flow is generated, the payload storage 110 constituting the billing system of probabilistic model 100p generates the flow table 310 for storing an entry composing of sampled partial data out of the payload of the IP packet 230 for each of directions A and B (step S710). In case of a 1,024-byte payload, the payload storage 110 generates the entries 411, 412, 413 and 414 by sampling only n bytes of data out of the 1024 bytes of data of the payload (step S720). In explaining the data billing method by the data billing system 100 of the probabilistic mode 100p according to some embodiments of the present disclosure, n is described to be 5 by way of example, although the present disclosure is not limited thereto.

Each of the entries 411 to 414 includes a BSN of 4 bytes and sampled data of 5 bytes. The sampled bytes of data constituting each of the entries 411 to 414 may be randomly selected from a sequence number space of [BSN, BSN+1023]. The BSN for the first entry 411 defines an ISN (initial sequence number) which is set by the sequence number used in an SYN or SYN flag packet or an SYN/ACK packet, and BSNs of the other entries 412, 413 and 414 are set to be respectively incremented by 1024 from the ISN. A description of determining the positions of the bytes Byte_{off1} to Byte_{off20} of data sampled in each flow will be omitted because it is a repeat of the described construction and operation of the billing system of the probabilistic model 100p. The payload storage 110 stores the respective generated entries 411 to 414 in the flow table 310 (step S730).

When the data billing system of probabilistic model 100p detects the retransmitted packet 320, the payload comparator 120 searches for a flow to which the retransmitted packet 320 has correspondence. If the corresponding flow is present, the payload comparator 120 calculates the BSN of the entries 411 to 414 to which the retransmitted packet 320 belongs and determines the random offsets 350 of the sampled bytes Byte_{off1} to Byte_{off20} of data by executing a hash function based on the calculated BSN and the flow key 340. The payload comparator 120 compares a data value of 5 bytes sampled based on the respective random offsets 350 with a data value of the corresponding 5 bytes among the sampled bytes Byte_{off1} to Byte_{off20} of data stored in the flow table 310 (step S740).

If the values of 5 bytes of data sampled based on the random offset 350 are respectively identical to the corresponding values of 5 bytes of data among the sampled bytes Byte_{off1} to Byte_{off20} stored in the flow table 310, the billing unit 130 classifies the retransmitted packet 320 as a normal retransmission packet and waives a charge for the retransmitted packet 320 (step S750). However, if the values of the 5 bytes of data sampled based on the random offset 350 are respectively different from the corresponding values of 5 bytes of data among the sampled bytes Byte_{off1} to Byte_{off20} of data stored in the flow table 310, the billing unit 130 classifies the retransmitted packet 320 as a malicious attack packet and proceeds to charge for the retransmitted packet 320 (step S760).

All the elements of the at least one embodiment of the present disclosure have been described as a single combined entity or as a single operatively combined entity, although the present disclosure is not necessarily limited thereto. As far as the present disclosure is concerned, one or more of all the elements may be selectively combined together for operation.

Although exemplary embodiments of the present disclosure have been described for illustrative purposes, those skilled in the art will appreciate that various modifications, additions and substitutions are possible, without departing from the various characteristics of the disclosure. Therefore, exemplary embodiments of the present disclosure have been described for the sake of brevity and clarity. Accordingly, one of ordinary skill would understand that the scope of the disclosure is not limited by the explicitly described above embodiments but by the claims and equivalents thereof.

### CROSS-REFERENCE TO RELATED APPLICATION

This application claims priority under 35 U.S.C §119(a) of Patent Application No. 10-2014-0007309, filed on Jan. 21, 2014 in Korea, the entire content of which is incorporated herein by reference. In addition, this non-provisional application claims priority in countries, other than the U.S., with the same reason based on the Korean patent application, the entire content of which is hereby incorporated by reference.

1. A data billing system, comprising:
a payload storage configured to store payloads of one or more Internet protocol (IP) packets transmitted over a mobile communication network;
a payload comparator configured to compare a payload of at least one retransmitted packet retransmitted among the IP packets based on a transmission control protocol (TCP) with at least one of the payloads stored in the payload storage; and
a billing unit configured to determine whether to bill for the retransmitted packet or not based on a comparison result of the payload comparator.

2. The data billing system of claim 1, wherein the billing unit is configured:
not to bill for the retransmitted packet which is regarded as a normal retransmission packet if the payload of the retransmitted packet is determined equal to the at least one of the payloads stored in the payload storage; and
to bill for the retransmitted packet which is regarded as a billable retransmission packet if the payload of the retransmitted packet is determined not equal to any of the payloads stored in the payload storage.

3. The data billing system of claim 1, wherein the payload storage is configured to store at least one entry including partial data selected from data constituting the payloads of the IP packets.

4. The data billing system of claim 3, wherein an offset value of a selected partial data is determined by using at least one hash function.

5. The data billing system of claim 4, wherein the hash function comprises a flow key generated per flow (per_flow_key) and a base sequence number of the entry as its inputs.

6. The data billing system of claim 5, wherein the flow key is determined by Equation:
per_flow_key=HMAC_{secret}_{_}_{key}(nonce)
where “HMAC” denotes a hash-based message authentication code, “secret_key” is a secret key of the data billing system, and “nonce” is a random number generated per flow.

7. The data billing system of claim 6, wherein the secret key is changeable regularly or randomly.

8. A data billing method, comprising:
generating a buffer for storing payloads of one or more Internet protocol (IP) packets transmitted over a mobile communication network;
storing all of the data constituting the payloads of the IP packets in the buffer;
comparing all the data of a payload of at least one retransmitted packet retransmitted among the IP packets based on a transmission control protocol (TCP) with all of data constituting a payload of at least one of the IP packets stored in the buffer; and
determining not to bill for the retransmitted packet if the payload of the retransmitted packet is determined equal to at least one of the payloads of the IP packets stored in the buffer, and to bill for the retransmitted packet if the payload of the retransmitted packet is determined not equal to any of the payloads of the IP packets stored in the buffer.

9. A data billing method for determining whether to bill for a packet retransmitted based on a transmission control protocol (TCP) over a mobile communication network, the method comprising:
generating a flow table for storing a part of payloads of one or more IP packets transmitted over the mobile communication network;
storing a selected portion of data constituting the payloads of the IP packets in the flow table;
comparing a selected portion of data constituting a payload of at least one retransmitted packet retransmitted among the IP packets based on the TCP with the selected portion stored in the flow table from the data constituting the payloads of the IP packets; and
determining not to bill for the retransmitted packet if the payload of the retransmitted packet is determined equal to at least one of the payloads of the IP packets, and to bill for the retransmitted packet if the payload of the retransmitted packet is determined not equal to any of the payloads of the IP packets.

10. A system for metering usage of data, comprising:
a payload storage configured to store payloads of one or more Internet protocol (IP) packets transmitted over a mobile communication network;
a payload comparator configured to compare a payload of at least one retransmitted packet retransmitted among the IP packets based on a transmission control protocol (TCP) with at least one of the payloads stored in the payload storage; and
a data usage measurer configured to measure a usage of data for the retransmitted packet based on a comparison result of the payload comparator.
